(19) United States
(12) Patent Application Publication
(10) Pub. No.: US 2007/0005812 A1
(43) Pub. Date: Jan. 4, 2007

(54) Asynchronous communicative exchange

(75) Inventor: David L. Moore, Warren, OR (US)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/172,135

(22) Filed: Jun. 29, 2005

(51) Int. Cl. G06F 15/16

(52) U.S. Cl. 709/250

(57) ABSTRACT

A system and electronic devices for use in an asynchronous communicative exchange over a network are described herein.

### TECHNICAL FIELD

Embodiments of the present invention relate generally to the field of networks, and more particularly to providing for an asynchronous communicative exchange over such networks.

### BACKGROUND

Network connectivity has dramatically changed the face and nature of communication by providing people the ability to communicate with one another in a variety of ways. Videoconferencing is one form of network communication that has become a virtual means of creating a face-to-face, conversational effect with participants who are unable to be in the same room. Although videoconferencing may help to overcome many logistical difficulties, it is limited by its synchronous nature and therefore presents scheduling challenges involved with having simultaneous communications between two or more people. These scheduling challenges may be exacerbated when participants are located in different time zones around the globe. E-mail is a form of network communication that may not encounter the same scheduling difficulties as videoconferencing due to its asynchronous nature. However, e-mail can lack the spontaneity of typical conversations.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates electronic devices capable of providing an asynchronous communicative exchange over a network, in accordance with an embodiment of the present invention;

FIGS. 2a-2c illustrate communicative segments generated by the electronic devices, in accordance with an embodiment of the present invention;

FIG. 3 illustrates a system including an electronic device and a video input device for use in recording a communicative segment, in accordance with an embodiment of the present invention;

FIG. 4 illustrates an operational flow of recording, parsing, and transmitting of the communicative segment by the electronic device, in accordance with an embodiment of the present invention;

FIG. 5 illustrates an operational flow of a response session upon receipt of an initiating communicative segment, in accordance with an embodiment of the present invention;

FIG. 6 illustrates a user interface of an electronic device for editing/reviewing the communicative exchange, in accordance with an embodiment of the present invention; and

FIG. 7 illustrates an electronic device in accordance with an embodiment of the present invention.

### DETAILED DESCRIPTION

Illustrative embodiments of the present invention may include electronic devices for use in developing and/or participating in an asynchronous communicative exchange over a network.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific procedures and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

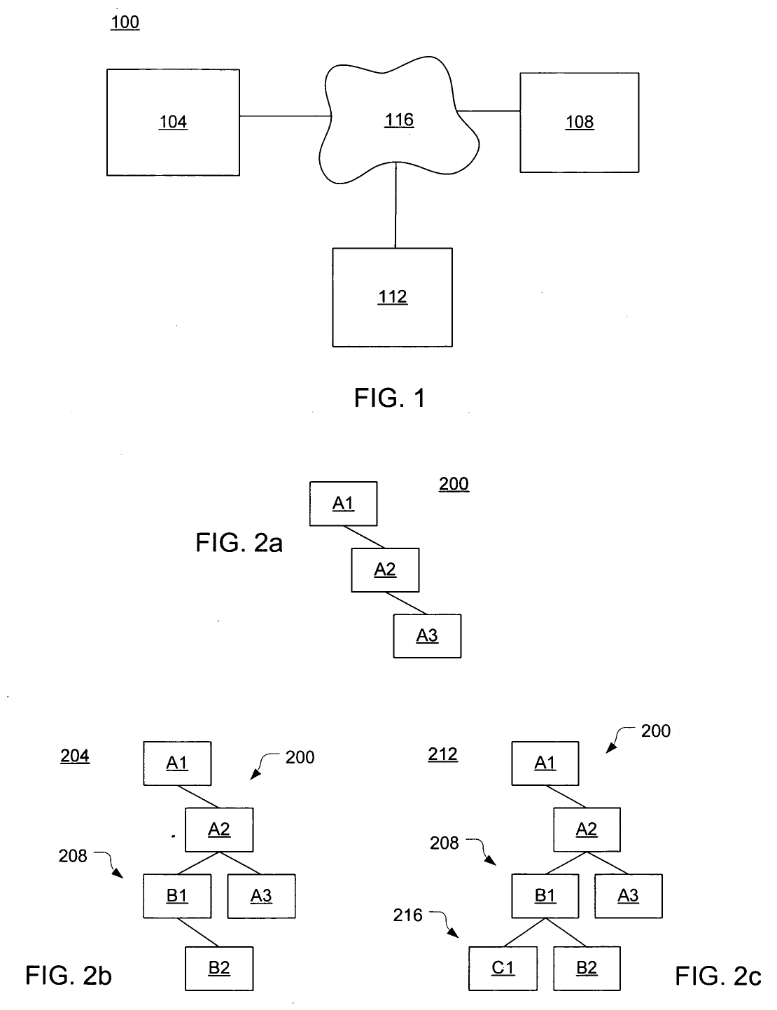

FIG. 1 illustrates a system 100 providing users the capability to engage in an asynchronous communicative exchange in accordance with an embodiment of the present invention. In particular, an electronic device 104, an electronic device 108, and an electronic device 112 may be coupled to one another through a network 116. Briefly, the electronic device 104 may begin a communicative exchange by recording an initiating communicative segment from a user. Elements of the initiating communicative segment may be identified and indexed to allow for a subsequent localized response to one or more of the elements. An element may include content such as a topic, a subject, a question, etc. and may provide for an associative point for which a particular response to that content may be linked. In various embodiments, the elements may be identified and indexed in a variety of ways, some of which are discussed below. The initiating communicative segment, and any associated indices, may be transmitted to a recipient device, such as electronic device 108.

FIG. 2a illustrates a graphical representation of the initiating communicative segment 200, in accordance with an embodiment of the present invention. In this embodiment, the initiating communicative segment 200 may include elements A1, A2, and A3.

A user operating the electronic device 108, may review the initiating communicative segment 200 through the electronic device 108 and the electronic device 108 may record any reactions/responses the user may have in a responsive communicative segment. Elements of the responsive communicative segment may also be identified and indexed. Each of the elements of the responsive communicative segment may be associated with the element A1, A2, or A3 of the initiating communicative segment 200 that most likely solicited the particular response.

FIG. 2b illustrates a graphical representation of a communicative exchange 204 including the initiating communicative segment 200 along with the associated responsive communicative segment 208 in accordance with an embodiment of the present invention. In this embodiment, the responsive communicative segment 208 may include elements B1 and B2. The element B1 may be associated with the element A1. In one embodiment, this association may be generated due to a temporal relationship between the elements A1 and B1, e.g., B1 may have occurred over a time period that was at or near a time period of an index point defining the element A1. In this embodiment, B2 may have immediately succeeded, and therefore is associated with, B1. In another embodiment, an element of the initiating communicative segment 200, e.g., the elemental period A2, may have occurred prior to the element B2, thereby creating an association between the elemental period B2 and A2. Said another way, in one embodiment an element may initially be associated with the most recently occurred element. In other embodiments, other associative formulas may be used to develop associations between responses and the initiating elements that most likely solicited the response.

In one embodiment, the communicative exchange 204, or parts thereof, may be transmitted back to the originating device 104 for review and/or comment. The communicative exchange 204 may additionally/alternatively be sent to another participant device, e.g., the electronic device 112, for review and/or comment. A user at the electronic device 112 may view the initiating communicative segment 200 and/or the responsive communicative segment 208. In one embodiment, responses from the user may be recorded by the electronic device 112 and associated with the elements that most likely solicited the responses. Referring now to FIG. 2c, there is illustrated a graphical representation of a resulting communicative exchange 212 including the initiation communicative segment 200, the responsive communicative segment 208, and a responsive communicative segment 216 recorded at the electronic device 112. In this embodiment, the responsive communicative segment 216 has one element C1, which is initially associated with the element B1.

In one embodiment, the communicative exchange 212, or parts thereof, may be sent to the electronic devices 104 and/or 108. The communicative exchange 212, which may have been created in an asynchronous fashion, may be viewed by user(s) at the electronic devices 104 and/or 108 in a synchronous manner. That is, review of the communicative exchange 212, with its integrated responses, may provide a virtual synchronous communication.

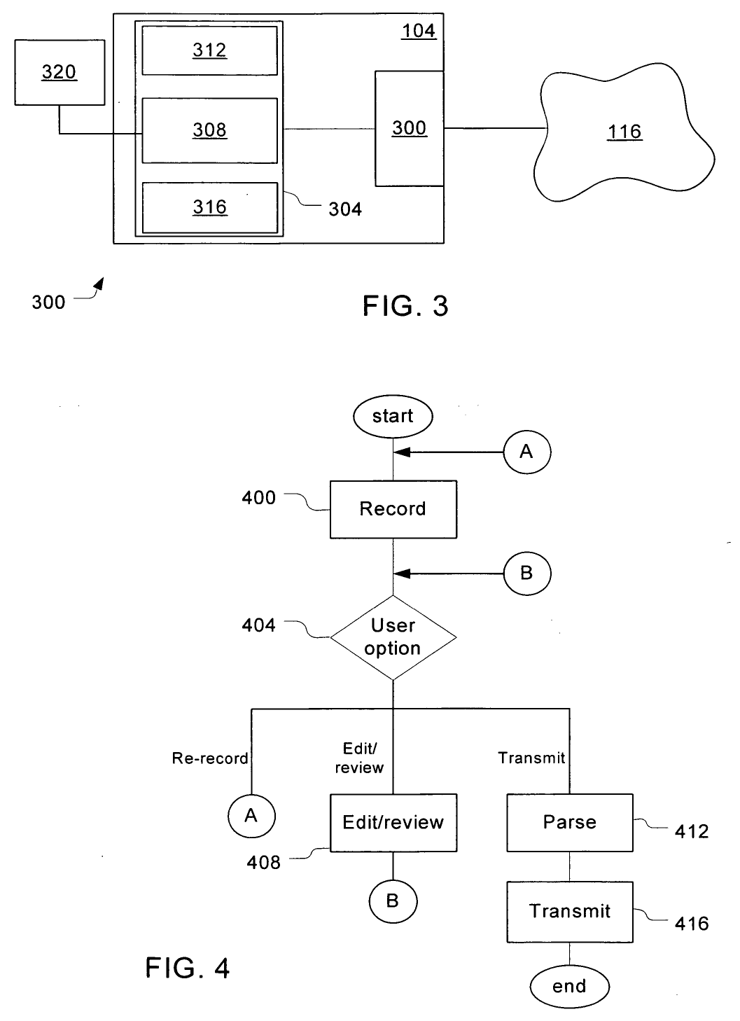

FIG. 3 illustrates a system 300 including the electronic device 104 in more detail in accordance with an embodiment of the present invention. In particular the electronic device 104 may have a network interface 300 communicatively coupled to the network 116. The network interface 300 may be coupled to a functional group 304, which may include functional units such as, but not limited to, a recording unit 308, a parsing unit 312, and/or a playback unit 316.

The recording unit 308 may have the capabilities to control the recording of the communicative segment 200 from a user. The recording unit 308 may be coupled to a recording device, e.g., an audio and/or video (A/V) input device 320 as shown in the present instance. In various embodiments, the A/V input device 320 may be coupled to, or embedded in, the electronic device 104. The operation of the recording unit 308 may be controlled based at least in part upon received input from user controls. In one embodiment, the user controls may allow the user flexibility in recording the communicative segment 200, e.g., by allowing the user to record the segment 200 with the recording unit 308, review the segment 200 with the playback unit 316, and, if necessary, rerecord the segment 200 or elements thereof. In one embodiment, when rerecording the segments or elements the segment, the segment or elements may be re-indexed.

Contemporaneously with, or sometime after, the recording of the communicative segment 200, the parsing unit 312 may identify and index the elements A1, A2, and A3 of the communicative segment 200. In one embodiment, the parsing unit 312 may identify the elements A1, A2, and A3 based at least in part upon the occurrence of indicators.

An indicator may be an active or passive indication of a break in the communicative segment 200 provided by the user. An active indication may be an indication that requires the user to interact with the electronic device 104 in order to define an element, e.g., a user input such as a keystroke, a mouse-click, an oral-command, display of a visual token, use of a pre-defined deliberate expression, gesture or sound, etc.

A passive indication may be a natural occurring visual/audio indicator that may suggest a natural break in the recorded discourse. For example, in one embodiment, a passive visual indication could be the user shrugging his or her shoulders. Gesticulating in such a manner may solicit a response in the course of a face-to-face, synchronous conversation; therefore, the parsing unit 312 may recognize this as an indicator of a possible solicitation and thereby define an element based on such an occurrence. The parsing unit 312 may include gesture recognition software to facilitate the identification of such a visual indicator. Examples of other passive visual indicators could include, but are not limited to, shrugging, shaking his/her head, or gesticulating in some other manner.

Likewise, passive audio indicators that may solicit a response in synchronous conversations may also serve as indicators of elements. Such audio indicators could include, but are not limited to, speech intonations denoting the end of a sentence, and in particular the end of a question, pauses, or speech recognition of interrogatives.

In various embodiments, the parsing unit 312 may be equipped to recognize one or more of the above indicators, or other indicators as appropriate for a particular embodiment.

In one embodiment, the parsing unit 312 may generate an index file having a record for each index including a unique identifier and a time stamp correlating to the elapsed playback time of the communicative segment 200 where an indicator occurred.

In one embodiment, the functional group 304 may cooperate with the network interface 300 to transmit the communicative segment 200 and the index file to the electronic device 108 over the network 116.

In the above embodiment, the electronic device 104 may have the functionality to record, parse, playback, and transmit the communicative segment 200. In other embodiments other electronic devices may be employed having only some of these functionalities and the above process may be distributed among a variety of electronic devices. For example, in one embodiment the identification and indexing of the elements A1, A2, and A3 may be done during or following transmission of the communicative segment 200 over the network 116.

In one embodiment, the parsing of the communicative segment 200 may be done at a separate electronic device, e.g., a server, to conserve processing resources at the recording electronic device. This may be done when the recording electronic device is a thin client, for example. In one embodiment, the thin client may have a recording unit but not a parsing unit, while the server may have a parsing unit but not a recording unit. In one embodiment the recording device may transmit a communicative segment to the server for parsing, and the server may transmit the indices back to the recording device and/or transmit the indices and the communicative segment on to the next electronic device for further review and/or comment.

In an alternative embodiment, the parsing of the communicative segment 200 may be done at the receiving electronic device 108.

FIG. 4 illustrates an operational flow of the recording, parsing, and transmitting of the communicative segment 200 by the electronic device 104, in accordance with an embodiment of the present invention. At the initiation of a session, which may be defined by a user input, the recording unit 308 may record the communicative segment 200, recording block 400. The user may then have option to edit/review, rerecord, or transmit the recorded segment 200 to a designated recipient, user-option block 404. If the user chooses to rerecord the communicative segment 200 the electronic device 104 may erase the first record and return to the recording block 400. If the user chooses to edit/review the communicative segment 200, the playback unit 316 may present the user with a graphical representation of the communicative segment 200, e.g., similar to the graphical representation illustrated in FIG. 2a, through a user interface, edit/review block 408. The user may interact with the user interface to selectively review some or all of the communicative segment 200. The playback unit 316 may output the selected portions of the recorded segment 200 through an appropriate output device, e.g., a display for video and/or speakers for audio, and return to the user-option block 404. Further discussion of edit/review functions is reserved for discussion below regarding edit/review at the electronic device 112.

If the user chooses to transmit the communicative segment 200 it may be parsed in such a manner to identify and index elements A1-A3, parsing block 412. The communicative segment 200 may then be transmitted to the receiving electronic device 416 along with any associated indices, transmitting block 416. Upon successful transmission, the electronic device 104 may end the session and await further instructions. In various embodiments, the parsing block 412 may automatically occur at or near the time of the recording block 400, sometime during transmission, e.g., at a network server, or upon receipt at the electronic device 108. In still another embodiment, the parsing block 412 may occur at the user's option.

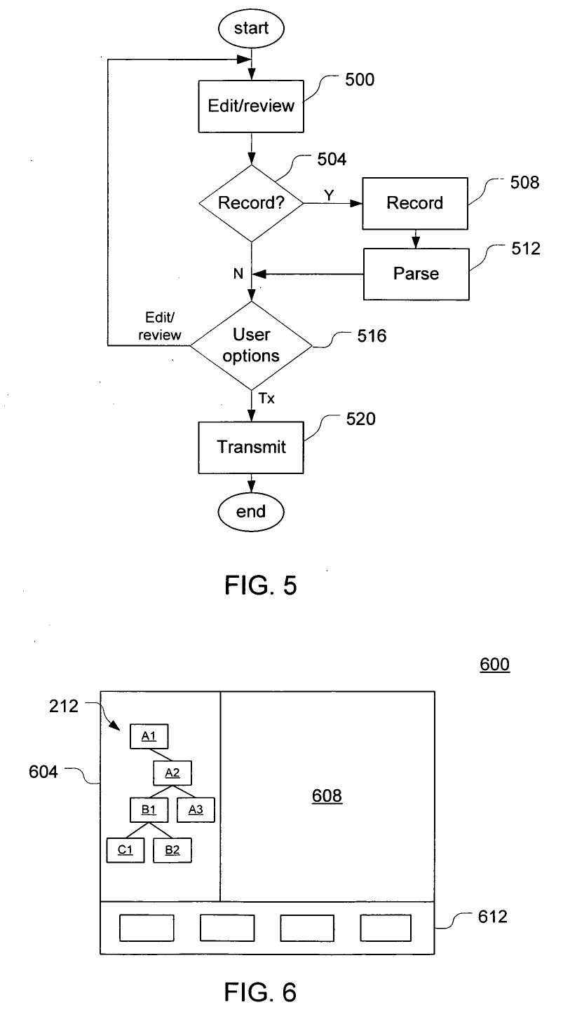

FIG. 5 illustrates an operational flow of a response session with the electronic device 108 upon receipt of the initiating communicative segment 200, in accordance with an embodiment of the present invention. In one embodiment, the receiving electronic device 108 may have a functional group including functional units such as, but not limited to, a playback unit, a parsing unit, and/or a recording unit. The functional units of the electronic device 108 may be similar to like-named units discussed above with reference to the electronic device 104.

A response session may be initiated by the user after the network interface of the electronic device 108 receives the communicative segment 200. In one embodiment, the playback unit may receive the communicative segment 200 from the network interface and output a graphical representation, e.g., similar to the graphical representation illustrated in FIG. 2a, on a user interface. The user may initiate a selective review of the communicative segment 200 and the playback unit may output, on an appropriate output device, e.g., a user interface, the selected portions of the communicative segment 200, edit/review block 500. If the user desires to record a response, record-option block 504, the recording unit may record the user while the playback unit outputs the communicative segment 200, recording block 508. In one embodiment, the playback unit may suspend playback of the communicative segment 200 when the recording unit is recording. In this embodiment, the playback unit may resume playback of the communicative segment 200 following the cessation of the recording at the preceding index point. In one embodiment, the cessation of recording may be determined by reference to indicators such as those discussed above.

The responsive communicative segment 208 may be parsed into elements B1 and B2 by the parsing unit of the electronic device 108, parsing block 512. The parsing unit may then associate the elements B1 and B2 with other elements based at least in part on when they occurred, thereby forming the communicative exchange 204. In various embodiments, the parsing block 512 may occur during transmission, e.g., at a network server or at a receiving device.

Following the recording of the communicative segment 208, the user may be presented with an option to edit/review or to transmit the communicative exchange 204, user-option block 516. If the user chooses to edit/review the communicative exchange 204, the playback unit may output a graphical representation of the communicative exchange 204, e.g., similar to the graphical representation illustrated in FIG. 2b, on the user interface, edit/review block 500. In one embodiment, the user may use this graphical representation to selectively review some or all of the communicative exchange 204. Further discussion of edit/review functions is reserved for discussion below regarding edit/review at the electronic device 112.

If the user chooses to transmit the communicative exchange 204, the electronic device 108 may cause the communicative exchange 204, or portions thereof, to be transmitted to designated receiving devices, transmit block 520. In one embodiment, if the electronic device 108 is sending the communicative exchange 204 to the originating electronic device 104, it may not be necessary to also send portions of the communicative exchange 204 that may still reside on the electronic device 104, e.g., the initiating segment 200 and/or the index file defining the elements A1-A3. In this embodiment, the electronic device 108 may only transmit the responsive communicative exchange 208 and associated indices defining elements B1-B2. The reconstruction-of the communicative exchange 204 may then take place at the originating electronic device 104 or during transmission in a server.

In one embodiment, the user of the electronic device 108 or receiving device 104 may choose to send the communicative exchange 204 on for further review/input from another participant, e.g., the electronic device 112.

The electronic device 112 may include a functional block with units similar to some or all of the units described above with reference to the electronic device 104 and/or the electronic device 108. Briefly, a network interface may receive the communicative exchange 204 from the network 116 and transfer the communicative exchange 204 to a playback unit to facilitate user edit/review. The playback unit may output the communicative exchange 204, or selected parts thereof, while a recording unit records the communicative segment 216. A parsing unit may then parse the communicative segment 216 into its elements, e.g., C1, and associate the element C1 with the element that most likely solicited the response, e.g., element B1, thereby creating the communicative exchange 212.

Following the recording and/or parsing of the communicative segment 216, the user may be presented with an edit/review option of the resulting communicative exchange 212. FIG. 6 illustrates a user interface 600 of the electronic device 112 that may be output by the playback unit to facilitate an edit/review of the communicative exchange, in accordance with an embodiment of the present invention. The user interface 600 may have a mapping section 604, a review section 608, and a control section 612. In one embodiment, the mapping section 604 may output the graphical representation of the communicative exchange 212 as shown. A user may edit the communicative exchange 212 by manipulating the graphics in the mapping section 604. The graphics may be manipulated directly, e.g., through a touch screen, and/or indirectly through the control section 612.

The communicative exchange 212 depicted in the mapping section 604 may serve to establish a playback queue for the playback unit. In the embodiment shown, all of the elements of the communicative exchange 212 are shown, and therefore may be included in the review. When review is selected, e.g., from the control section 612, the playback unit may sequentially output the elements of the communicative exchange 212 in the review section 608. In this embodiment, the elements may include video segments and therefore the corresponding video may be output in the review section 608. Other embodiments may include only audio and may not need the review section 608.

The playback queue developed based on the graphical model may sequence the playback order through any number of traversal algorithms such as inorder, preorder, postorder, etc. For example, a preorder traversal may generate a playback queue through a root-left-right process. In the illustrated embodiment, this may translate to a playback queue as follows: A1-A2-B1-C1-B2-A3.

In one embodiment, the user may wish to review only a portion of the communicative exchange 212. In this case, the user may selectively hide the elements/segments that are not of immediate interest. In one embodiment, all elements dependent upon a hidden element may also be hidden through association. When a review of the displayed communicative exchange is selected, only the visible elements/segments may be incorporated into the queue. In one embodiment, the user may wish to selectively delete elements/segments of the communicative exchange 212 and may do so in a similar manner.

Various authority settings may allow user editing-access to some or all of portions of the communicative exchange 212. For example, in one embodiment, only elements recorded on the editing device may be edited on the editing device, e.g., element C1 on the electronic device 112.

In one embodiment, the user may wish to edit the attachment points of elements of the communicative exchange 212. For example, in one embodiment, the user may determine that the element C1 is better associated with B2, rather than with B1 which is what it was initially associated with. In this embodiment, the user may make the desired adjustment in the mapping section 604. This could be done by clicking and dragging the element C1 to B2, by selecting C1 and editing properties associated with the element, or by some other manner. The playback unit may then generate a playback queue based on the new configuration of the communicative exchange 212.

In one embodiment, during review of the communicative exchange 212 in the review section 608, an indication of the particular element being reviewed may appear on the mapping section 604. In one embodiment, the indication may be the particular element being highlighted.

In an embodiment, a participant-response indication, appearing either in the mapping section 604 or in the review section 608, may facilitate the dynamic generation of the playback queue during the review process. In one embodiment, as the review process is occurring, the participant-response indication may alert the reviewer that a particular participant has an upcoming response to the element being reviewed. For example, while a reviewer is reviewing the A2 element of the communicative segment 200 an indication may alert the reviewer that the user B has a response. If the reviewer is interested in B's response, he/she may cause the communicative segment 208 to be viewed. If not, the communicative segment 200 may continue to the element A3.

In one embodiment, the user may wish to edit indexing points of segments of the communicative exchange 212. For example, if the user determines the communicative segment 208 would be better represented with less indexing points, he/she may cause the elements B1 and B2 to be combined into one element.

In various embodiments, the user may edit the communicative exchange 212 in a variety of other ways to, e.g., add index points and/or change the location of existing index points.

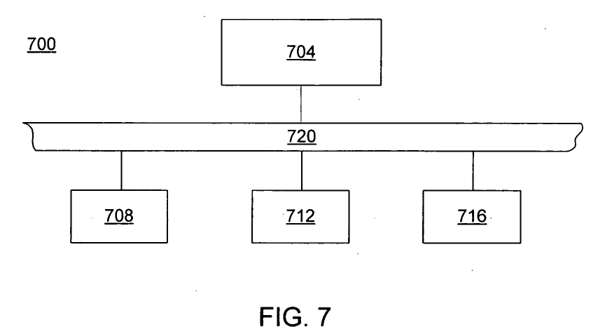

FIG. 7 illustrates an electronic device 700 in accordance with an embodiment of the present invention. The electronic device 700 may be similar to electronic devices 104, 108, and/or 112, shown and described above. The electronic device 700 may include a processing device 704. In various embodiments, the processing device 704 may be a processor, an application-specific integrated circuit, a controller, etc.

The electronic device 700 may also include a storage medium 708, a graphics processor 712, and an input/output module 716 coupled to the processing device 704 by way of an interconnect 720, as shown. The storage medium 708 may store instructions that the processing device 704 may execute to cause one or more units (e.g., recording, parsing, and/or playback units) of the electronic device 700 to perform any of the various operations described above. In various embodiments, the storage medium 708 may include, but is not limited to, read-only memory (ROM); random-access memory (RAM); magnetic disk storage media; optical storage media (e.g., Digital Versatile Disk, Compact Disk); and flash memory devices (e.g., USB flash drive, Secure Digital (SD) memory card, Compact Flash (CF) memory card, Smart Media (SM) memory card, Multi Media Card (MMC), MemoryStick (MS) card).

Examples of the input/output modules 716 include but are not limited to an A/v input device, a keyboard, a keypad, cursor control devices, a display, a network interface, and so forth. Examples of the interconnect 720 include but are not limited to a peripheral control interface (PCI) bus, and Industry Standard Architecture (ISA) bus, and so forth.

In various embodiments, the electronic device 700 may be, but is not limited to, a server, a personal digital assistant, a wireless mobile phone, a laptop computing device, or a desktop computing device.

Accordingly, embodiments providing an asynchronous communicative exchange over a network have been described. Although the present invention has been described in terms of the above-illustrated embodiments, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This description is intended to be regarded as illustrative instead of restrictive on embodiments of the present invention.

What is claimed is:

1. An electronic device comprising:
a network interface configured to couple the electronic device to a network; and
a parsing unit coupled to the network interface and configured
to identify and index an element of a communicative segment based at least in part on an occurrence of an indicator within the communicative segment; and
to cooperate with the network interface to transmit at least the communicative segment, the index, or both to a recipient device over the network.

2. The electronic device of claim 1, wherein the index is to provide for a subsequent localized response from the recipient device to the element.

3. The electronic device of claim 1, wherein the indicator comprises an indication provided by a user in the communicative segment selected from the group consisting of a user input, a pause, an intonation, and a gesture.

4. The electronic device of claim 1, wherein the parsing unit is further configured to identify and index a plurality of elements of the communicative segment based at least in part on a corresponding plurality of indicators.

5. The electronic device of claim 1, further comprising:
a recording unit, coupled to the parsing unit, configured to generate the communicative segment by recording a user over time and to provide the communicative segment to the parsing unit.

6. The electronic device of claim 1, wherein the communicative segment comprises at least a video file, an audio file, or both.

7. The electronic device of claim 1, wherein the network interface is configured to receive the communicative segment from the network and to provide the first communicative segment to the parsing unit.

8. An electronic device comprising:
a network interface configured to receive, over a network, a first communicative segment and one or more indices corresponding to one or more elements of the first communicative segment; and
a parsing unit coupled to the network interface and configured to
to receive the first communicative segment and the one or more indices from the network interface;
to receive a second communicative segment having a first element at a first time period; and
to associate the first element of the second communicative segment with a first one of the one or more indices based at least in part on the first time period.

9. The electronic device of claim 8, further comprising:
a user interface;
a playback unit coupled to the network interface and the user interface and configured to receive the first communicative segment from the network interface and to output the first communicative segment on the user interface; and
a recording unit configured to record the second communicative segment and to transmit the second communicative segment to the parsing unit.

10. The electronic device of claim 9, wherein the playback unit is further configured to suspend output of the first communicative segment during the first time period, and to resume output of the first communicative segment following the first time period.

11. The electronic device of claim 10, wherein the playback unit is further configured to resume output of the first communicative segment following the first time period at a point in the first communicative segment corresponding to the first one of the one or more indices.

12. The electronic device of claim 9, wherein the playback unit is further configured to provide a graphical representation on the user interface of the first and second communicative exchanges and the association between the first element of the second communicative exchange and a first one of the one or more elements of the first communicative exchange corresponding to the first one of the one or more indices.

13. The electronic device of claim 9, wherein the parsing unit is further configured to identify the first element based at least in part on an occurrence of a first indicator.

14. The electronic device of claim 13, wherein the first indicator comprises an indication provided by a user in the second communicative segment selected from the group consisting of a user input, a pause, an intonation, and a gesture.

15. The electronic device of claim 9, wherein the second communicative segment has a second element at a second time period, the parsing unit further configured to identify the second element based at least in part on an occurrence of a second indicator, and to associate the second element with a second one of the one or more indices based at least in part on the second time period.

16. The electronic device of claim 9, wherein the playback unit is further configured to develop a playback queue for the one or more elements of the first communicative segment and the first element of the second communicative segment based at least in part on the first one of the one or more indices.

17. A system comprising:
a video input device; and
an electronic device coupled to the video input device and configured to receive, over a network, a first communicative segment and one or more indices corresponding to one or more elements of the first communicative segment, the electronic device having
a user interface;
a playback unit coupled the user interface and configured to output the first communicative segment on the user interface; and
a recording unit coupled to the video input device and configured to control the video input device in a manner to record a second communicative segment having a first element at a first time period.

18. The system of claim 17, further comprising; and
a parsing unit coupled to the recording unit and configured to receive the second communicative segment and associate the first element with a first one of the one or more indices based at least in part on the first time period.

19. The system of claim 18, wherein the playback unit is further configured to suspend output of the first communicative segment during the first time period, and to resume output of the first communicative segment after the first time period.

20. The system of claim 18, wherein the parsing unit is further configured to identify the first element based at least in part on an occurrence of a first indicator.

21. The system of claim 20, wherein the first indicator comprises an indication provided by a user in the second communicative segment selected from the group consisting of a user input, a pause, an intonation, and a gesture.

22. A storage medium having instructions stored therein, which, when executed by a processing device, cause the processing device to
identify and index a first element of a first communicative segment based at least in part on an occurrence of an indicator within the first communicative segment; and
to transmit at least the first communicative segment, the index, or both to a recipient device over a network.

23. The storage medium of claim 22, wherein the instructions, which, when executed by a processing device, further cause the processing device to
record the communicative segment.

24. The storage medium of claim 23, wherein the instructions, which, when executed by the processing device, further cause the processing device to
associate the first element of the first communicative segment with a second element of a second communicative element; and
develop a playback queue based at least in part upon the association of the first element to the second element.
